(19) United States
(12) Patent Application Publication
(10) Pub. No.: US 2007/0215406 A1
(43) Pub. Date: Sep. 20, 2007

(54) Power steering clutch control during engine start

(76) Inventors: Mike M. McDonald, Macomb, MI (US); Chandra S. Namuduri, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/375,436

(22) Filed: Mar. 14, 2006

(51) Int. Cl. B62D 5/06

(52) U.S. Cl. 180/417

(57) ABSTRACT

A control system that reduces a load on an engine during a cranking event includes a first module that determines whether the engine is being cranked. A second module regulates a power steering clutch that is driven by the engine to a disengaged state when the engine is being cranked.

### FIELD OF THE INVENTION

The present invention relates to vehicles, and more particularly to power steering clutch control during engine start.

### BACKGROUND OF THE INVENTION

Vehicles include steering systems that enable an operator to regulate the direction in which the vehicle is traveling. Traditionally, steering systems include a steering wheel that is manipulated by the operator. The steering wheel is connected to steering components that regulate the steering angle of the wheels based on a rotational position of the steering wheel. The steering components include, but are not limited to, tie rods, steering knuckles and the like. A steering gear couples the steering wheel to the steering components and translates rotational movement of the steering wheel into linear movement of the steering components.

Power steering systems have been developed to assist the operator in steering the vehicle. Power steering systems include a hydraulic steering pump that provides pressurized hydraulic fluid to a powered steering gear to reduce operator steering effort. The steering pump is driven by the engine. As a result, the steering pump loads the engine requiring the engine to produce additional drive torque to drive the steering pump. During engine start or cranking, the starter must drive both the engine and the steering pump.

### SUMMARY OF THE INVENTION

Accordingly, the present invention provides a control system that reduces a load on an engine during a cranking event. The control system includes a first module that determines whether the engine is being cranked. A second module regulates a steering pump clutch that is driven by the engine to a disengaged state when the engine is being cranked.

In other features, the clutch is a magneto-rheological (MR) clutch. The second module provides no current to the MR clutch to regulate the clutch to the disengaged state.

In other features, the second module regulates the clutch to an engaged state when the vehicle speed is greater than zero. The control system further includes a vehicle speed sensor that is responsive to a vehicle speed.

In still another feature, the control system further includes a current amplifier that provides a current signal to the clutch to regulate engagement of the clutch.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of an exemplary vehicle including a power steering clutch according to the present invention;

FIG. 2 is a flowchart illustrating steps performed by the clutch control system according to the present invention; and

FIG. 3 is a schematic illustration of exemplary modules that execute the clutch control of the present invention.

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, or other suitable components that provide the described functionality.

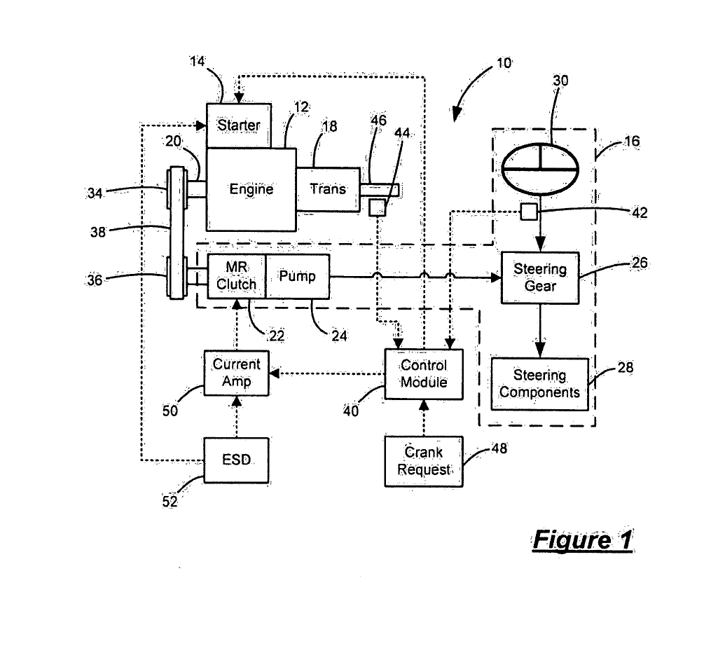

Referring now to FIG. 1, an exemplary vehicle 10 includes an engine 12, a starter 14, a steering system 16 and a transmission 18. The engine 12 produces drive torque to drive components of the steering system 16 and the transmission 18. The engine 12 and the starter 14 are coupled via an engine flywheel (not shown). More specifically, the starter 14 selectively drives the flywheel, which is fixed for rotation with a crankshaft 20 of the engine 12. The starter 14 drives or cranks the engine 12 during an engine start-up period based on a crank command signal (CRANK), discussed in further detail below. More specifically, the starter 14 drives the crankshaft 20 to drive pistons (not shown) within cylinders (not shown). The pistons draw in air and compress an air/fuel mixture within the cylinders. The air/fuel mixture combusts to drive the pistons within the cylinders.

Although the steering system 16 is generally described herein, further detail of the steering system 16 is provided in commonly assigned U.S. Pat. App. Pub. No. US2004/0194459, entitled Magneto-Electrohydraulic Power Steering System, the disclosure of which is expressly incorporated herein by reference. The steering system 16 includes a clutch 22, a steering pump 24, a steering gear 26, steering components 28 and a steering wheel 30. The clutch 22 is preferably a magneto-rheological (MR) clutch that is driven by the engine 12. The clutch 22 may also be any electrically controllable clutch such as an electro-rheological, magnetic particle, electro-magnetic or electro-hydraulic clutch. More specifically, the engine 12 and the clutch 22 are coupled via a belt system 38. The engine 12 and the clutch 22 include pulleys 34,36, respectively, that are coupled for rotation by a belt 38. The pulley 34 is coupled for rotation with the crankshaft 20 of the engine 12. The engine 12 drives the clutch 22, which selectively drives the steering pump 24 to provide pressurized hydraulic fluid to the steering gear 26.

A control module 40 regulates operation of the vehicle 10 based on the control system of the present invention. A steering sensor 42 is responsive to rotation of the steering wheel 30 and generates a steering signal based thereon. A vehicle speed sensor 44 is responsive to the rotational speed (RPM) of an output shaft 46 of the transmission 18 and generates a speed signal based thereon. A crank request input 48 is provided and selectively generates the CRANK signal based on an operator input or other vehicle control logic. For example, the crank request signal can be generated by an operator turning a key to a crank position. The control module 40 regulates operation of the starter 14 based on the crank request signal. More specifically, if the CRANK signal indicates that the engine 12 is to be cranked, a flag is set equal to TRUE (e.g., CRANK=TRUE) and the control module 40 regulates the starter 14 to crank the engine 12.

A current amplifier 50 generates a current signal to the MR clutch 22 based on control signals generated by the control module. Alternatively, the current amplifier 50 can be replaced by a pulse-width modulated (PWM) chopper circuit (not shown). The PWM chopper circuit uses a high frequency switching transistor to regulate the average amount of voltage applied to the clutch 22 and therefore controls the average amount of current.

An energy storage device (ESD) 52 provides electrical power to the current amplifier 50. The ESD 52 can include, but is not limited to, a battery or a super-capacitor. The ESD 52 also provides electrical power to the starter 14. The current signal regulates operation of the MR clutch 22. More specifically, when no current signal is provided to the MR clutch 22, the MR clutch 22 is in a disengaged state, whereby no torque is transferred to the steering pump 24. When a maximum current signal is provided to the MR clutch 22, the MR clutch 22 is in a fully engaged state, whereby full torque is transferred to the steering pump 24. The current signal can be regulated between zero and maximum to operate the MR clutch 22 in a partially engaged state, whereby a variable amount of torque is transferred to the steering pump 24.

The control system of the present invention selectively decouples the engine 12 from driving the steering pump 24. More specifically, during engine start or cranking, the MR clutch 22 is operated in the disengaged state by providing zero current to the MR clutch 22. In this manner, the starter 14 only drives the engine 12 and not the steering pump 24. As a result, there is a reduced load on the starter 14 and less energy is required to crank the engine 12. The control system also determines whether the vehicle 10 is moving before operating the MR clutch 22 in the disengaged state. More specifically, if the vehicle 10 is moving, the MR clutch 22 is operated in one of the partially engaged or the fully engaged states. If the engine 12 is being cranked and the vehicle 10 is not moving, the MR clutch 22 is operated in the disengaged state.

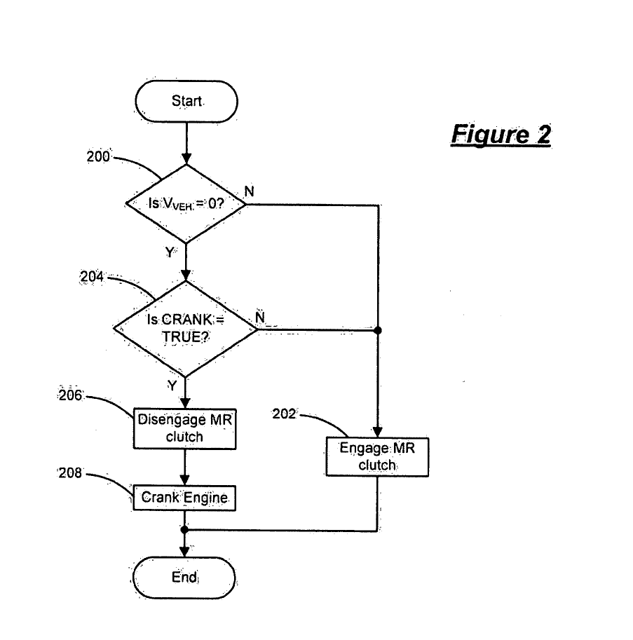

Referring now to FIG. 2, a flowchart illustrates the steps executed by the engine control system of the present invention. In step 200, control determines whether the vehicle speed (V_{VEH}) is equal to zero. If V_{VEH} is not equal to zero, control continues in step 202. If V_{VEH} is equal to zero, control continues in step 204. In step 204, control determines whether the engine 12 is to be cranked (e.g., CRANK=TRUE). If the engine 12 is not to be cranked, control continues in step 202. If the engine 12 is to be cranked, control continues in step 206. In step 202, control engages the MR clutch 22 and control ends. In step 206, control disengages the MR clutch 22. In step 208, control cranks the engine 12 and control ends.

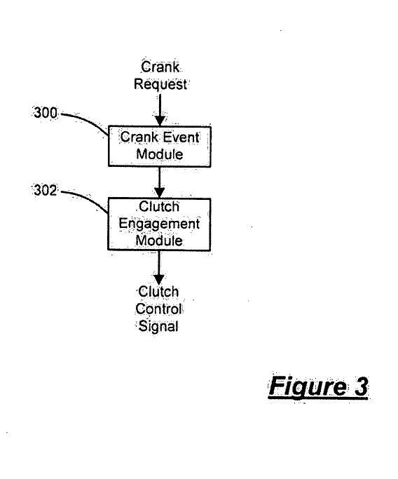

Referring now to FIG. 3, exemplary modules that execute the clutch control of the present invention are schematically illustrated. The modules include a crank event module 300 and a clutch engagement module 302. The crank event module 300 determines whether the engine 12 is to be cranked based on a crank request signal. The clutch engagement module 302 regulates the clutch between the disengaged state and the engaged state based on a signal generated by the crank event module 300.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A control system that reduces a load on an engine during a cranking event, comprising:
a first module that determines whether said engine is being cranked; and
a second module that regulates a steering pump clutch that is driven by said engine to a disengaged state when said engine is being cranked.

2. The control system of claim 1 wherein said clutch is a magneto-rheological (MR) clutch.

3. The control system of claim 2 wherein said second module provides no current to said MR clutch to regulate said clutch to said disengaged state.

4. The control system of claim 1 wherein said second module regulates said clutch to a non-disengaged state when said vehicle speed is greater than zero.

5. The control system of claim 4 further comprising a vehicle speed sensor that is responsive to a vehicle speed.

6. The control system of claim 1 further comprising a current amplifier that provides a current signal to said clutch to regulate engagement of said clutch.

7. A method of regulating power steering clutch operation of a vehicle during engine start, comprising:
determining whether said engine is being cranked; and
operating a power steering clutch in a disengaged state when said engine is being cranked to decouple a power steering pump from said engine.

8. The method of claim 7 wherein said power steering clutch is a magneto-rheological (MR) clutch.

9. The method of claim 8 wherein said step of operating said power steering clutch in a disengaged state includes inhibiting current to said MR clutch to regulate said clutch to said disengaged state.

10. The method of claim 7 further comprising operating said power steering clutch in a non-disengaged state when a vehicle speed is greater than zero.

11. The method of claim 10 further monitoring said vehicle speed using a vehicle speed sensor.

12. The method of claim 7 further comprising regulating a current amplifier to provides a current signal to said power steering clutch to regulate engagement of said power steering clutch.

13. A method of operating a power steering clutch during engine start, comprising:
monitoring presence of an engine crank request signal;
cranking said engine when said engine crank request signal is present; and
operating said power steering clutch in a disengaged state when a crank signal is present to decouple a power steering pump from said engine.

14. The method of claim 13 wherein said power steering clutch is a magneto-rheological (MR) clutch.

15. The method of claim 14 wherein said step of operating said power steering clutch in a disengaged state includes inhibiting current to said MR clutch to regulate said clutch to said disengaged state.

16. The method of claim 13 further comprising operating said power steering clutch in a non-disengaged state when a vehicle speed is greater than zero.

17. The method of claim 16 further monitoring said vehicle speed using a vehicle speed sensor.

18. The method of claim 13 further comprising regulating a current amplifier to provides a current signal to said power steering clutch to regulate engagement of said power steering clutch.
